(19) United States
(12) Patent Application Publication
(10) Pub. No.: US 2025/0001426 A1
(43) Pub. Date: Jan. 2, 2025

(54) METHODOLOGY FOR OBTAINING ROLLABLE AND SHELF STABLE PURE MILLET FLOUR

(71) Applicant: Tata Consumer Products Limited, Kolkata, West Bengal (IN)

(72) Inventors: Urmila Ramasamy, Kolkata, West Bengal (IN); Shashikala Madakasira Narasimhachary, Kolkata, West Bengal (IN); Vivek Gaur, Kolkata, West Bengal (IN); Vikas Gupta, Kolkata, West Bengal (IN); Namrata Ghaisas, Kolkata, West Bengal (IN); Nagappa Malleshi, Kolkata, West Bengal (IN)

(73) Assignee: Tata Consumer Products Limited, Kolkata, West Bengal (IN)

(21) Appl. No.: 18/688,349

(22) PCT Filed: Apr. 27, 2023
(86) PCT No.: PCT/IN2023/050415

§ 371 Date: Feb. 29, 2024

(30) Foreign Application Priority Data
May 27, 2022 (IN) 202231030578

(51) Int. Cl. B02B 5/02; A23P 30/20; B02B 1/02; B02B 1/04

(52) U.S. Cl. CPC B02B 5/02; A23P 30/20; B02B 1/02; B02B 1/04

(57) ABSTRACT

The present invention provides a method for preparing rollable and shelf stable pure millet flour comprising the following steps: a) cleaning millet grains to remove foreign material; b) pressure steaming millet grains; c) cooling of millets obtained from step b); d) oven drying or vacuum drying of millets obtained from step c); c) milling with 5 to 25% by weight of pregelatinized millet flour; thereby obtaining millet flour which is substantially rollable and have high shelf life.

This application claims priority from Indian patent application No. 202231030578 dated 27 May 2022 and the disclosure therein is referred to herein its entirety.

### FIELD OF THE INVENTION

The present invention in general relates millet flour (jowar, bajra and ragi) with substantially high rollability and shelf life. More particularly, the present invention relates to a uniquely designed methodology for obtaining millet flour which is rollable shelf stable and does not become rancid on storage for a substantial period of time.

### TECHNICAL BACKGROUND OF THE INVENTION

It is known that millet flours mostly and commonly refer to jowar, bajra and ragi flours.

Now, unprocessed millet flours, in general, lack gluten, and therefore do not possess sufficient binding strength when mixed with water to knead into a soft dough. Such doughs are difficult to be handled by untrained consumers and necessitate the use of hot water to knead the dough.

The other problem that millet flours show is limited shelf-stability. The flour becomes rancid and is unfit for consumption, usually within a week. Due to this, millet flours do not have a long shelf-stability, which is usually desired to be at-least six months.

So, millet flours known in the market are not satisfactory in respect of rollability. To achieve rollability, they are often mixed with wheat flour. Mixing with wheat flour results in hampering the purity of millet flours and often users have to compromise with acceptability in respect of taste in particular. Further, it does not solve the problem of limited shelf-life for these flours. Though these millet flours in the market quote a shelf-life of 3 months to 9 months, their actual shelf-life is limited to 2 or 3 months, evidenced by the development of rancid like bitterness.

Therefore, rollable and shelf-stable flours do not exist in the market at the present to the best of knowledge of the applicants.

The technology known in this field for improving rollability and shelf life compromises with purity of the end product and compromises with taste of the end product. That apart, there is no known technology which can be universally applied to all three of jowar, bajra and ragi grains. Furthermore, technology known involves multiple unit operations and thus time consuming apart from not being manageable by any layman.

The above drawbacks are overcome by the technology disclosed by the present invention which enables user friendliness since, untrained customers can apply and also it ensures substantially high rollability and shelf stability of the resultant millet flour.

That apart the instant invention ensures that to knead the dough no hot water is needed and cold water suffices.

Additionally, the instant invention ensures applicability of the technology on all three of jowar, bajra and ragi.

Another important aspect of the instant invention is that it is not only simple but also, it ensures that no rice flour or wheat flour is mixed at any stage.

### OBJECTIVES OF THE INVENTION

It is the principal objective of the present invention to provide a methodology for preparing millet flours which have substantially high rollability and shelf stability.

It is another objective of the present invention to provide a methodology for preparing millet flours which is applicable on all three of bajra, jowar and ragi.

It is a further objective of the present invention to provide a methodology for preparing millet flours which by virtue of its improved binding strength ensures that the dough can be easily handled by untrained customers.

It is another object of the present invention to provide a methodology for preparing millet flours which does away with physical and chemical deterioration of millet flours thereby extending the shelf life of millet flours to more than six months.

It is another very important object of the present invention to provide absolutely pure Millet flours with enhanced rollability and shelf stability.

How the foregoing objects are achieved will be clear from the following description. In this context it is clarified that the description provided is non-limiting and is only by way of explanation.

### SUMMARY OF THE INVENTION

Accordingly, the present invention provides a method for preparing rollable and shelf stable pure millet flour comprising the following steps:
a) cleaning millet grains to remove foreign material;
b) pressure steaming millet grains;
c) cooling of millets obtained from step b);
d) oven drying or vacuum drying of millets obtained from step c);
e) milling with 5 to 25% by weight of pregelatinized millet flour;
thereby obtaining millet flour which is substantially rollable and have high shelf life.

According to preferred embodiments of the present invention:
step b) comprises pressure steaming jowar grains for around 4 to 6 minutes whereby moisture content is 20% to 25% and step d) involves oven drying of millets at 60° C. or vacuum drying for 2 hours;
step b) comprises pressure steaming bajra grains for around 6 to 8 minutes whereby moisture content is 20% to 25% and step d) involves oven drying of millets at 60° C. or vacuum drying for 2 hours;
step b) comprises pressure steaming ragi grains for around 3 to 7 minutes whereby moisture content is 25% to 30% and step d) involves oven drying of millets at 60° C. or vacuum drying for 2 hours;
the method further consisting of packaging of the obtained millet flour and cooling it down for preparing roti from the rollable dough so obtained;
step a) comprises cleaning of the grains, washing them in water and allowing them to soak in water to obtain 25% to 30% moisture;
steps b) and c) comprise steaming the grains in a rotary cooker at a pressure of 1 to 3 Kg/cm² for 3 to 8 minutes, turning off the steam and taking the resultant grains out for cooling;
step e) comprises milling with a pregelatinized flour at 5 to 25% by weight of processed grains such that the pregelatinized flour is manufactured applying extrusion, wherein the raw millet flour at 5 to 25% moisture is extruded through a twin screw extruder, the temperature of the third zone being kept at 120° C. to 150° C. to effect dextrinization of the extrudate, drying the extrudate at 50° C. to 80° C. and powdering before milling with the hydrothermally treated millet grains.

The present invention also provides millet flour obtained by the method as described herein wherein said millet flour has substantially high shelf life and rollability.

The millet flour obtained is any one of Jowar, Bajra and Ragi.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings:—

FIG. 1 illustrates rollable millet rotis of jowar, bajra and ragi according to the present invention.

FIG. 2 is a flow chart of a preferred embodiment of the technology according to the present invention.

### DETAILED DESCRIPTION OF THE INVENTION

Having described the main features of the invention above, a more detailed and non-limiting description of a preferred embodiment will be given in the following paragraphs with reference to the accompanying drawings.

This invention employs a combination of a hydrothermally treated millet flour and a 5-25% by weight, of a pre-gelatinized millet flour, to obtain rollable roti for jowar, bajra and ragi. Of which, jowar and bajra are shelf-stable for at-least six months, and ragi for four months. FIG. 2 is a flow chart of a preferred embodiment of the methodology of the present invention.

With the proposed technology, the resulting millet flour can be kneaded with cold water into a soft dough. The dough gives sufficient resistance to deformation, thus enabling sheeting and rolling of the dough as compared to doughs from unprocessed flours.

### Sheeting of the Dough is Achieved Due to the Following Reasons—

Hydrothermal treatment of the millet grains enables the flour to hold more water and prevents the dough from sticking to the rolling base.

Addition of a pre-gelatinized millet flour, in which the starch in the millet flour is more fluid and malleable to mix and binds with the flour particles.

Thus, the hydrothermal treatment improves the rehydration ability, binding properties of the flour, and the addition of the pre-gelatinized flour further improves the rehydration ability of the flour, and enhances the dough's resistance to deformation, it's malleability and binding strength. This synergistic effect has been achieved by the inventors for the first time in this field of technology and thus transformed the methodology according to the present invention.

Hydrothermal treatments have been studied to inactivate the lipid oxidation enzymes. Due to the high content of unsaturated fatty acids, and lipid oxidizing enzymes in millets, the flour deteriorates physically and chemically.

Physical deterioration is often manifested as a lack of binding strength between the dough particles, while chemical deterioration manifests as unacceptable odours, tastes and flavours due to lipid oxidation.

The technology proposed in this invention employs a steaming technology to achieve at-least 20% moisture of the cooked millet grains, thus prolonging the shelf-life.

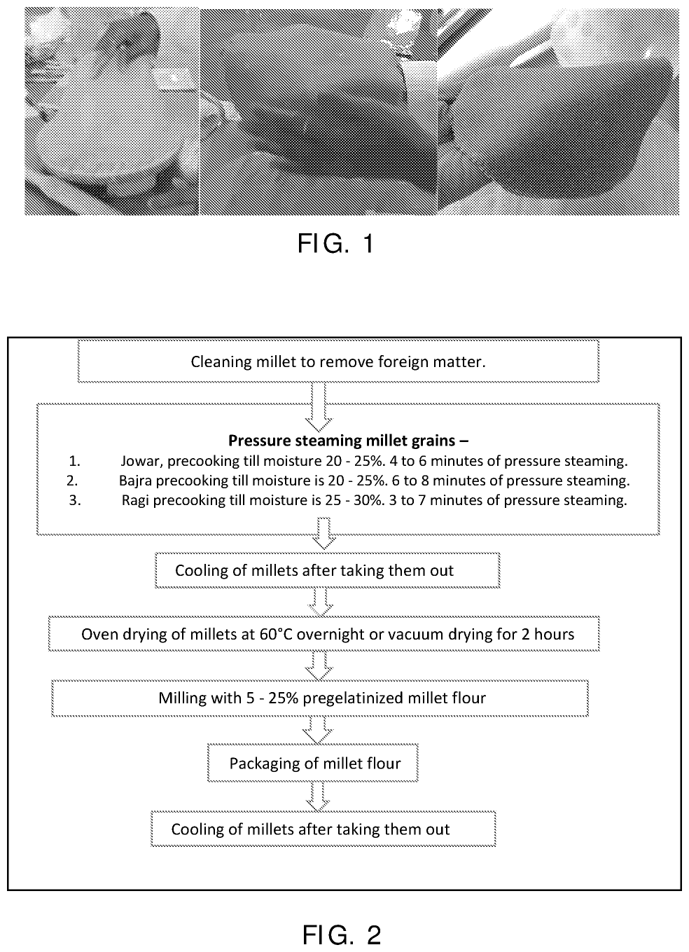

The rollable rotis of jowar, bajra and ragi according to the present invention are shown in FIG. 1.

The millet flour is produced comprising the steps as described below and also given in the flowchart in FIG. 2—
Cleaning the grains, washing them in water, and allowing them to soak in water to obtain 25% to 30% moisture content.
Steaming the grains in a rotary cooker at a pressure of 1 to 3 Kg/cm² for 3-8 minutes, turning off the steam and taking them out for cooling.
Drying these grains in a rotary oven at 60° C. for 6 to 8 hours or in a vacuum oven for 2 hours.

The processed grains are milled with a pre-gelatinized flour at 5-25% by weight of the processed grains and packaged in 12PET/12METPET/60POLY before subjecting them for shelf-life studies.

The pre-gelatinized flour is manufactured using extrusion, wherein, the raw millet flour at 5% to 25% moisture is extruded through a twin screw extruder, and the temperature of the third zone is 120° C. to 150° C. to effect dextrinization of the extrudate. This extrudate is dried at 50-80° C. and is powdered before milling with the hydrothermally treated millet grains.

The following experimental details are provided in support of the invention:

Storage Conditions for Shelf-Life Studies were
a) Control samples (fresh, not rancid) were placed at −20° C.
b) Samples placed under Accelerated Storage Testing conditions (AST) at 38° C. and 90% relative humidity for samples prepared at 150 Kg, and AST of 40° C. and 75% relative humidity for samples prepared at 500 g. Conversion factor for both the AST conditions to real time is the same.
c) Samples placed under real time (ambient conditions at 25° C. and 75% relative humidity).

### Details Concerning Experimental Data:

### Rollable Millet Flours

### A. Example 1—Preparation of a Jowar Flour

1. Around 500 gm of jowar of moisture content of around 11 to 13% was mixed with around 100 gm of water and pressure cooked for three whistles at 200° C. on an induction oven, until around 9 to 11 minutes and the moisture content of jowar was around 20 to 25%. Upon cooling, the grains were retrieved, and oven dried at 60° C. in a regular oven for 6 to 8 hours. Dried grains of moisture around 6 to 7% were harvested and milled with 5 to 25% of a pre-gelatinized jowar flour to obtain rollable jowar flour.

2. Around 150 Kg of jowar of moisture of around 11 to 13% were washed with water until clean and allowed to soak in water till moisture was around 20 to 25%. The grains were cooked in rotary cooker for 4 to 6 minutes, under 1 to 2 Kg/cm² of pressure until the moisture was around 21 to 32%. Cooked grains were dried further—
a) Using a rotary tray drier at 60° C. for 6 to 8 hours.
b) Using a vacuum oven for 2 hours.

### B. Example 2—Preparation of Bajra Flour

1. Around 500 g of bajra of moisture content around 11 to 13% were mixed with around 106 g of water. Bajra grains were pressure cooked at 200° C. using an induction oven for 2 whistles, until around 9 to 11 minutes and the moisture content of bajra was around 20 to 25%. Upon cooling, the grains were retrieved and oven dried at 60° C. for 6 to 8 hours. Dried grains of moisture around 6 to 7% were harvested and milled with 5-25% of a pre-gelatinized bajra flour to obtain rollable bajra flour.

2. Around 150 Kg of bajra of moisture content around 11 to 13% were washed with water until clean, and allowed to soak in water till moisture was 25 to 30%. The grains were cooked in rotary cooker for 6 to 8 minutes, under 1 to 3 Kg/cm² of pressure until the moisture was around 20 to 25%. Cooked grains were dried further—
a. Using a rotary tray drier at 60° C. for 6 to 8 hours.
b. Using a vacuum oven for 2 hours.

### C. Example 3—Preparation of Ragi Flour

Around 500 g of ragi of moisture content around 12 to 14% was mixed with around 110 g of water and pressure cooked for 1 whistle, until 3 to 7 minutes and till the moisture was around 25 to 30%. Upon cooling, the grains were retrieved, and oven dried at 60° C. for 6 to 8 hours. Dried grains of moisture around 4 to 6% were harvested and milled with 5 to 25% of a pre-gelatinized ragi flour to obtain rollable ragi flour.

### Analyses of Rollable Millet Flours—

### Results of Shelf-Life Study—

1. Moisture, sensorial rancidity check for 500 g samples of jowar flour (with pre-gelatinized flour) under AST.

The results comprising moisture and sensorial data are manifested in table 1.

TABLE 1

| Duration of storage | | | | | |
|---|---|---|---|---|---|
| | AST | Unprocessed jowar | | Processed jowar | |
| | converted to | flour in AST | | flour in AST | |
| AST | real time | Moisture | Rancidity | Moisture | Rancidity |
| (days) | (months) | % | score* | % | score* |
| 15 | 1 | 10.5 | 1 | 8.8 | 0 |
| 60 | 4 | 12.4 | 1 | 11.9 | 0 |
| 75 | 5 | 12.5 | 1 | 11.9 | 0 |
| 105 | 7 | 12.4 | 1 | 12.4 | 0 |
| 120 | 8 | 11.3 | 1 | 12.1 | 0 |
| 136 | 9.1 | 12 | 1 | 12.1 | 0 |
| 196 | 13.1 | 11.3 | 1 | 11.9 | 0 |

2. Moisture, sensorial rancidity check for 500 g samples of bajra flour (with pre-gelatinized flour).

Table 2 below represents the moisture and sensorial data for shelf-life pullouts of bajra flour.

TABLE 2

| Duration of storage | | Unprocessed bajra | | Processed bajra | |
|---|---|---|---|---|---|
| | AST converted | flour under AST | | flour under AST | |
| AST | to real time | | Rancidity | | Rancidity |
| (days) | (months) | Moisture | score* | Moisture | score* |
| 0 | 0 | 9.5 | 0 | 9.5 | 0 |
| 30 | 4 | 11.4 | 1 | 11.2 | 0 |
| 113 | 15.1 | 11.7 | 1 | 11.3 | 0 |

*Rancidity score of 1 indicates detection of rancidity, 0 indicates absence of rancidity.

Processed jowar (500 g) and bajra (500 g) clearly point to absence of rancidity until at-least 12 months. Also, the rotis from these flours were rollable until at-least 12 months.

The unprocessed flour samples of bajra were rancid. The rotis from these flours were not rollable.

3. Shelf-life-Moisture and Free fatty acids % (FFA) for jowar, bajra and ragi flours.

TABLE 3
Moisture free fatty acids values for
shelf-life pullouts of jowar flours

| Millet flour analyses | | AST | | | |
|---|---|---|---|---|---|
| | Zero Day | 30 day | 60 day | 90 day | 120 day |
| Jowar regular | | | | | |
| dried | | | | | |
| Moisture % | 6.51 | 6.95 | 7.01 | 7.11 | 7.24 |
| FFA | 0.046 | 0.23 | 0.51 | 0.697 | 0.741 |
| Jowar vacuum | | | | | |
| dried | | | | | |
| Moisture | 5.6 | 5.6 | 5.629 | 5.83 | 5.99 |
| FFA | 0.042 | 0.242 | 0.46 | 0.535 | 0.613 |
| Bajra regular | | | | | |
| dried | | | | | |
| Moisture | 7.5 | 8.8 | 8.5 | 8.59 | 9.03 |
| FFA | 0.023 | 0.241 | 0.212 | 0.239 | 0.28 |
| Bajra vacuum | | | | | |
| dried | | | | | |
| Moisture | 7.35 | 7.47 | 7.51 | 7.55 | 7.99 |
| FFA | 0.023 | 0.259 | 0.213 | 0.232 | 0.266 |
| Ragi regular dried | Zero day | 55 day | | | |
| Moisture | 8.9 | 10.7 | | | |
| FFA | 1.442 | 2.55 | | | |

The flour moisture must not be more than 12% by wt. for unprocessed jowar flour, 13.0% by wt. for unprocessed bajra flour and 10% by wt. for unprocessed ragi flour, as per FSSAI standards. For processed flours which contain pregelatinized flours, there are no limits established as such.

The moisture and free fatty acid (FFA) values are only slightly incremental. The FFA are within limits, indicating that the samples are not subject to lipid oxidation, and there is no rancidity. The FFA values must not exceed 10%. This was also evidenced from sensorial studies below by the absence of rancidity and bitterness in the millet samples as tasted by the panelists.

Shelf-life-sensorial detection of rancidity in millet flours-Random panelists were served millet roti and flour under storage conditions of control, ambient and AST and were asked to rate the samples for presence of rancidity with respect to the control (fresh sample or it's equivalent).

Table on Rancidity

| Rancidity score* | |
|---|---|
| AST | Ambient - real time |

| | Jowar | Bajra | Ragi | Jowar | Bajra | Ragi |
|---|---|---|---|---|---|---|
| Month 1 | 0 | 0 | 0 | 0 | 0 | 0 |
| Month 2 | 0 | 0 | 0 | 0 | 0 | 0 |
| Month 4 | 0 | 0 | 1 | 0 | 0 | 1 |

*Rancidity score legend
0 indicates no rancidity as reported by panelists
1 indicates presence of rancidity as reported by panelists

Samples as old as 4 months under AST, which is 8 months* for jowar, 16 months* for bajra (conversion of AST into real time), show no development of rancidity and were acceptable. Samples of ragi which were 1.8 months under AST, which is 3.7 months when converted in real time, showed no development of rancidity and were acceptable.

*Conversion factor was 2 for jowar flour and ragi flour and 4 for bajra flour. The table on rancidity shows that after 4 months, slight rancidity is developed in ragi flour in ambient sample, and rancidity was high in AST sample. With this rancidity data, it can be concluded that the shelf-life of ragi is extended to upto 4 months. Whereas, for jowar and bajra, the shelf life is at least 6 months.

TABLE 4
Particle size of millet flours

| | Sieve analysis passes |
|---|---|
| Millet flour | through 250 Micron |
| Bajra flour, vacuum dried | 90-93 |
| Jowar flour, regular dried | 90-93 |
| Jowar flour, vacuum dried | 95-98 |
| Bajra flour, regular dried | 90-93 |

The particle sizes of the flours are comparable to other flours used for baking rotis.

### Rollability Test of Millet Flours Using Rolling Pin—

Rollability in-house for jowar, bajra and ragi flours is shown in Table 5 below.

TABLE 5

| | | Flour | Water | Diameter | Thickness |
|---|---|---|---|---|---|
| | Sample | amount | added | rollable | achieved |
| No. | name | in g | in g | in cm | in mm |
| 1 | Jowar | 20 | 20 | 18 to 21 | 0.5 to 1 |
| | regular | | | | |
| 2 | Jowar | 20 | 20 | 18 to 24 | 0.5 to 1 |
| | vacuum | | | | |
| 3 | Bajra regular | 20 | 16 | 19 to 22 | 0.5 to 1 |
| 4 | Bajra | 20 | 14 | 19 to 22 | 0.5 to 1 |
| | vacuum | | | | |
| 5 | Ragi regular | 20 | 15 | 18 to 20 | 0.5 to 1 |

The rollability measurements conducted in-house point that the processed flours of jowar, bajra and ragi have excellent rollability ability, they were rollable up-to approximately 19 cm to 21 cm in diameter, on an average.

### Rollability Test and Texture of Millet Roti—Outside the Limits of Pregelatinized Flours Used—

Rollability of bajra flour mixed with 5% and 25% pregelatinized bajra flour, separately is shown in Table 6 below:

TABLE 6

| Pregelatinized | | | Characteristics | | |
|---|---|---|---|---|---|
| flour addition | Rollability | Rollability | Kneading | Rolling | |
| to bajra | characteristics | in cm | of dough | of dough | Roti |
| 5% | Rolling with | 17.3 | Not as | Cracks | Roti slightly |
| | difficulty* | | soft | observed | harder than |
| | | | | on edges | 15%, |
| | | | | | grittiness |
| | | | | | felt in |
| | | | | | mouthfeel |
| 25% | Rolling | 19.2 | Soft, too | Smooth | Taste of |
| | very well | | sticky | | bajra |
| | | | | | diluted, like |
| | | | | | mixed with |
| | | | | | wheat flour. |
| | | | | | Stickiness |
| | | | | | in |
| | | | | | mouthfeel |
| | | | | | while |
| | | | | | chewing the |
| | | | | | roti. |

*as compared to 15% addition pf pregelatinized bajra flour to processed bajra flour.

At 5% addition of the pregelatinized bajra flour to bajra flour (processed), the dough was rollable with difficulty as compared to the addition of 15% pregelatinized bajra flour. The rotis were rollable only upto 17 cm as compared to the usual 19 to 20 cm (See table 5 above). Also, the roti was slightly harder than the roti prepared by the addition of 15% pregelatinized bajra flour.

At 25% addition of the pregelatinized flour to bajra flour (processed), the dough was too sticky. Though it rolled well, the roti was very flat in taste, where the taste of bajra was diluted and panelists thought that the flour was mixed with wheat. Also, upon chewing the roti, the panelists observed stickiness in the mouthfeel.

Contrary to what is stated above it can be found from the results in tables 1 to 6 as provided hereinbefore, that good results are obtained in the end product in respect of rollability, when milling with 5% to 25% by weight of pregelatinized millet flour is effected which is the surprising result according to the present invention, as determined by experimentation. This is also true in respect of shelf stability of the end product.

### Nutritional Data

| | |
|---|---|
| Nutritional | Per 100 g |

| parameters | Jowar | Bajra |
|---|---|---|
| Energy (kCal) | 382 | 390 |
| Protein (g) | 10 | 10 |
| Fat (g) | 2.4 | 4.6 |

| | |
|---|---|
| Trans fat (%) | <Detection limit |

| | | |
|---|---|---|
| Free fatty acid (% oleic | 0.05 | 0.02 |
| acid) | | |
| Total carbohydrates (g) | 80 | 77 |
| Total dietary fibre (%) | 7.5 | 10.4 |
| Crude fibre (%) | 0.96 | 0.66 |

Nutritionally, both jowar and bajra flours contain more than 6 g of dietary fibre, enabling them to be claimed as flours “rich in fibre”.

### Preparation of Pre-Gelatinized Millet Flours—

### Example 4—Pre-Gelatinized Jowar Flour

Jowar grains were cleaned, milled to flour of moisture around 15 to 20%, and extruded via a twin-screw extruder. Extrusion temperature was around 120° C. to 160° C. Extrudates were dried in a regular oven at 60 to 70° C. and milled to powder using a hammer mill.

### Example 5—Pre-Gelatinized Bajra Flour

Bajra grains were cleaned, milled to flour of moisture around 15 to 20%, and extruded via a twin-screw extruder. Extrusion temperature was around 120° C. to 160° C. Extrudates were dried in a regular oven at 60 to 70° C. and milled to powder using a hammer mill.

### Example 6—Pre-Gelatinized Ragi Flour

Ragi grains were cleaned, decorticated till around 6 to 10% bran remaining in the grains. Grains were milled to flour of moisture around 15 to 20% and extruded via a twin-screw extruder. Extrusion temperature was around 120° C. to 160° C. Extrudates were dried in a regular oven at 60 to 70° C. and milled to powder using a hammer mill.

Analyses of pre-gelatinized millet flours is shown in Table 8 below:

TABLE 8

| Sr. No. | Parameter | Results |
|---|---|---|
| 1 | Expansion ratio of | 2 to 4 |
| | extrudate* | |
| 2 | Moisture of | For jowar and bajra, moisture |
| | extruded flour % | values were around 5 to 7% |
| | | For ragi, moisture values were |
| | | around 3 to 6% |

*The expansion ratio of the extrudate was calculated as A ratio of A to B, where A is the outer diameter of the extrudate and B is the internal diameter of the dye, used for extrusion.

It would be clear from hereinbefore that the present invention provides the following non-limiting advantages:
1. The present invention provides convenience to the consumer—for both untrained and trained (those accustomed to prepare millet roti) consumers, pan India, in terms of handling and shelf-stability.
2. Millet flours can be easily kneaded into a dough by using cold water or ambient temperature water instead of using hot water.
3. The millet dough from processed grains, is natural without any additives and can be easily rolled with a rolling pin on a rolling base.
4. The millet flours comprise 100% only millets, resulting in 100% jowar flour, 100% bajra flour and 100% ragi flour. Thus, purity and taste is not compromised.
5. High fibre content, due to lack of completely decorticating the grains.

From the above description it should be clear that all objectives of the present invention are met.

The present invention has been described with reference to some drawings and a preferred embodiment purely for the sake of understanding and not by way of any limitation and the present invention includes all legitimate developments within the scope of what has been described herein before and claimed in the appended claims.

1. A method for preparing rollable and shelf stable pure millet flour comprising the following steps:
a) cleaning millet grains to remove foreign material;
b) pressure steaming millet grains;
c) cooling of millets obtained from step b);
d) oven drying or vacuum drying of millets obtained from step c);
e) milling with 5 to 25% by weight of pregelatinized millet flour;
thereby obtaining millet flour which is substantially rollable and have high shelf life.

2. The method as claimed in claim 1, wherein step b) comprises pressure steaming jowar grains for around 4 to 6 minutes whereby moisture content is 20% to 25% and step d) involves oven drying of millets at 60° C. or vacuum drying for 2 hours.

3. The method as claimed in claim 1, wherein step b) comprises pressure steaming bajra grains for around 6 to 8 minutes whereby moisture content is 20% to 25% and step d) involves oven drying of millets at 60° C. or vacuum drying for 2 hours.

4. The method as claimed in claim 1, wherein b) comprises pressure steaming ragi grains for around 3 to 7 minutes whereby moisture content is 25% to 30% and step d) involves oven drying of millets at 60° C. or vacuum drying for 2 hours.

5. The method as claimed in claim 1, further consisting of packaging of the obtained millet flour and cooling it down for preparing roti from the rollable dough so obtained.

6. The method as claimed in claim 1, wherein step a) comprises cleaning of the grains, washing them in water and allowing them to soak in water to obtain 25% to 30% moisture.

7. The method as claimed in claim 1, wherein steps b) and c) comprise steaming the grains in a rotary cooker at a pressure of 1 to 3 Kg/cm² for 3 to 8 minutes, turning off the steam and taking the resultant grains out for cooling.

8. The method as claimed in claim 1, wherein step e) comprises milling with a pregelatinized flour at 5 to 25% by weight of processed grains of jowar/bajra/ragi as applicable, such that the pregelatinized flour is manufactured applying extrusion, wherein the raw millet flour at 5 to 25% moisture is extruded through a twin screw extruder, the temperature of the third zone being kept at 120° C. to 150° C. to effect dextrinization of the extrudate, drying the extrudate at 50° C. to 80° C. and powdering before milling with the hydrothermally treated millet grains.

9. Millet flour obtained by the method of claim 1, wherein said millet flour has substantially high shelf life and rollability.

10. Millet flour obtained by the method of claim 1, wherein said millet flour is any one of Jowar, Bajra and Ragi.
